(19) United States
(12) Patent Application Publication
(10) Pub. No.: US 2012/0187187 A1
(43) Pub. Date: Jul. 26, 2012

(54) TWO-WAY SYMBOLOGICAL COMMUNICATION BETWEEN ELECTRONIC DEVICES

(75) Inventors: Zachary W. Duff, Newmarket (AU); Christopher J. McGrath, Wights Mountain (AU)

(73) Assignee: LAI Games Australia Pty Ltd, Northbridge (AU)

(21) Appl. No.: 13/010,677

(22) Filed: Jan. 20, 2011

(51) Int. Cl. G06F 17/00; G06K 5/00

(52) U.S. Cl. 235/382; 235/375

(57) ABSTRACT

Symbological communication operates to communicate information and data between mobile and electronic devices. Using certain information, an optical symbology is generated and displayed on the display screen of the mobile device. The optical symbology is read by an optical scanner coupled to the electronic device to read the optical symbology and decode the information contained therein. The electronic device uses the decoded information for different tasks, including providing authorized access to additional functionality of the electronic device by the user. After user interaction with the electronic device, it generates another optical symbology for on its display screen. The user of the mobile device would then capture the image of this optical symbology using the camera function of the mobile device. Applications operating on the mobile device decode all of a part of the additional information for local use or to communicate further to remote servers for additional use or tracking.

### TECHNICAL FIELD

The present disclosure relates, in general, to communication protocols and, more particularly, to two-way symbological communication between electronic devices.

### BACKGROUND

A barcode is an optical machine-readable representation of data. Originally, barcodes represented data in the line widths and the spacings of a group of parallel lines. This type of barcode is generally referred to as linear or one dimensional (1D) barcode, optical code, or symbology. Optical code protocols have also been defined using patterns of squares, dots, hexagons and other geometric patterns within images. These types of symbol-pattern based optical codes are generally referred to as two dimensional (2D) matrix codes, optical codes, or symbologies. Although 2D systems often use symbols other than bars or lines, they are generally referred to as barcodes as well. Barcodes can be read by optical scanners called barcode readers, or scanned from an image by special software. The representative information is determined based on the detected spaces between the various symbols or the variances in reflected light off of the code.

As technology continues to advance, new optical code protocols have been defined to add another dimension to 2D barcode systems in order to increase the amount of data capable of being represented in the symbology or to create a more robust code. These three dimensional (3D) codes often use a 2D code as the basis for the optical code and then add another layer according to the specific intended use. For example, in certain manufacturing facilities, where the caustic environment might prevent affixing a label onto one or more particular manufacturing components or products, 3D codes have been etched directly into the component or product. The third dimension added, then, in such 3D codes is a z-axis, which creates a raised optical code or symbology. For such 3D codes, instead of measuring the spaces between the various symbols or variances in reflected light, this type of 3D code measures the height of each line or symbol to determine the representative information.

Another type of 3D optical code uses color as the additional dimension. Such a color-based 3D optical code may also begin with a 2D code, such as Denso Wave Incorporated's QR CODE®, Symbol Technologies' PDF417 symbology, or the like, and adds color layers to the symbols. Examples of color-based 3D optical codes include ColorZip Media Inc.'s COLORCODE® and COLORZIP®, Content Idea of Asia Co., Ltd.'s PM CODE™, and the like. Depending on the number of colors used in such 3D optical codes, they may represent data anywhere from 1 Kb all the way to 1.2 Gb, for the more advanced codes, which is sufficient to hold enough data for short videos or animations.

In general, optical codes are used to gather information quickly in order to manage various types of processes, such as manufacturing, inventory, logistics, supply chain, and the like. These information gathering tasks are often generically referred to as Auto ID Data Capture (AIDC). New uses for such optical codes have also included advertising and marketing. Optical codes displayed on traditional advertising may be scanned by personal mobile devices. These devices then decode the optical codes for the hidden information. The information may provide access to a vendor website, a presentation related to the product, or the like. Thus, the flexibility of optical codes has begun to grow beyond the traditional AIDC functions.

### BRIEF SUMMARY

The various representative embodiments of the present disclosure are directed to communication systems that use optical symbologies to communicate information and transfer data bi-directionally between electronic devices. The communication can be between any electronic devices but occurs generally between a mobile device and an electronic device. Using either user-entered information, device-generated information, or information obtained through the network connection of the mobile device or some combination of both, an optical symbology is generated and displayed on the display screen of the mobile device. By pointing or swiping the optical symbology in relation to an optical scanner coupled to the electronic device, the electronic device is able to read the optical symbology and decode the information contained therein. The electronic device may use the decoded information for a variety of different tasks, including providing authorized access to additional functionality of the electronic device by the user. Upon completion by the user of his or her interaction with the electronic device, it generates another optical symbology that is displayed on the electronic device display screen. This optical symbology may include information or data that is based on the data encoded into the first optical symbology or may be completely separate information. The user of the mobile device would then capture the image of this optical symbology using the camera function of the mobile device. Applications operating on the mobile device may decode all or a part of the additional information for local use or to communicate further to remote servers for additional use or tracking.

Additional representative embodiments of the present disclosure are directed to methods that include scanning a first optical symbology at a first electronic device. The first optical symbology is displayed on a second electronic device. The methods also include decoding, at the first electronic device, a first set of information encoded into the first optical symbology, processing, at the first electronic device, the decoded first set of information, generating a second optical symbology using a second set of information at the first electronic device, and displaying the second optical symbology on a display screen of the first electronic device.

Still further representative embodiments of the present disclosure are directed to methods of communication that include generating a first optical symbology based on a first set of information, displaying the first optical symbology on a visual display, presenting the displayed first optical symbology to a scanner of an electronic device, capturing an image of a second optical symbology displayed on a display of the electronic device, and decoding a second set of information embedded in the second optical symbology.

Further representative embodiments of the present disclosure are directed to computer program products for a game. The computer program products include computer-readable media having program code recorded thereon. The program code includes code to scan a first optical symbology at a first electronic device. The first optical symbology is displayed on a second electronic device. The program code also includes code to decode, at the first electronic device, a first set of information encoded into the first optical symbology, code to process, at the first electronic device, the decoded first set of information, code to generate a second optical symbology using a second set of information at the first electronic device, and code to display the second optical symbology on a display screen of the first electronic device.

Further representative embodiments of the present disclosure are directed to computer program products for symbological communication. The computer program products include computer-readable media having program code recorded thereon. The program code includes code to generate a first optical symbology based on a first set of information, code to display the first optical symbology on a visual display, code to present the displayed first optical symbology to a scanner of an electronic device, code to capture an image of a second optical symbology displayed on a display of the electronic device, and code to decode a second set of information embedded in the second optical symbology.

Further representative embodiments of the present disclosure are directed to electronic devices that include at least one processor, a display device coupled to the processor, an image capture device coupled to the processor, a memory coupled to the processor, and a symbological communication module stored on the memory. When executed by the processor, the executing symbological communication module configures the electronic device to scan a first optical symbology at a first electronic device. The first optical symbology is displayed on a second electronic device. The executing symbological communication module configures the electronic device to decode, at the first electronic device, a first set of information encoded into the first optical symbology, to process, at the first electronic device, the decoded first set of information, to generate a second optical symbology using a second set of information at the first electronic device, and to display the second optical symbology on a display screen of the first electronic device.

Further representative embodiments of the present disclosure are directed to mobile devices that include at least one processor, a visual display device coupled to the processor, an image capture device coupled to the processor, a memory coupled to the processor, and a symbological communication module stored on the memory. When executed by the processor, the executing symbological communication module configures the mobile device to generate a first optical symbology based on a first set of information, display the first optical symbology on the visual display device, present the displayed first optical symbology to a scanner of an electronic device, capture an image of a second optical symbology displayed on a display of the electronic device using the image capture device, and decode a second set of information embedded in the second optical symbology.

The foregoing has outlined rather broadly the features and technical advantages of the present disclosure in order that the detailed description that follows may be better understood. Additional features and advantages will be described hereinafter which form the subject of the claims of this disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the present disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present teachings, reference is now made to the following description taken in conjunction with the accompanying drawings.

FIG. 1 is a conceptual diagram illustrating a mobile device configured according to one embodiment of the present disclosure.

FIG. 2 is a conceptual diagram illustrating a game device configured according to one embodiment of the present disclosure.

FIG. 3A is a conceptual block diagram illustrating a symbological communication system configured according to one embodiment of the present disclosure.

FIG. 3B is a conceptual block diagram illustrating a symbological communication system configured according to one embodiment of the present teachings.

FIG. 3C is a conceptual block diagram illustrating a symbological communication system configured according to one embodiment of the present disclosure.

FIG. 3D is a conceptual block diagram illustrating a symbological communication system configured according to one embodiment of the present disclosure.

FIG. 4 is a conceptual diagram illustrating a symbological vending system configured according to one embodiment of the present disclosure.

FIG. 5 is a conceptual block diagram illustrating a symbological ATM network configured according to one embodiment of the present teachings.

FIG. 6 is a functional block diagram illustrating example blocks executed at an electronic device to implement one embodiment of the present disclosure.

FIG. 7 is a functional block diagram illustrating example blocks executed at a mobile device to implement one embodiment of the present disclosure.

FIGS. 8A and 8B are perspective diagrams illustrating an optical scanner unit configured according to one embodiment of the present disclosure.

FIG. 8C is a perspective diagram illustrating a gaming device configured according to one embodiment of the present disclosure.

FIG. 9 illustrates exemplary computer system which may be employed to implement the various aspects and embodiments of the present disclosure.

### DETAILED DESCRIPTION

In the detailed description below, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions of the detailed description may be presented in terms of algorithms or symbolic representations of operations on data bits or binary digital signals stored within a computing system memory, such as a computer memory. These algorithmic descriptions or representations are examples of techniques used by those of ordinary skill in the art to convey the substance of their work to others skilled in the art.

An algorithm is here, and generally, considered to be a self-consistent sequence of operations or similar processing leading to a desired result. In this context, operations or processing involve physical manipulation of physical quantities. Typically, although not necessarily, such physical quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like, refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

One aspect common to the existing uses of optical codes is the one-way nature of the data flow. Optical codes may be printed onto labels and then affixed to a particular object. Using a scanner or mobile device with the appropriate capabilities, the user accesses the data represented by the symbology of the optical code through scanning the label. In more ad hoc code applications, the optical code is generated based on some input provided by a user through a user interface, such as a computer, kiosk, website, and the like. For example, optical codes are now being generated and transmitted to users' mobile devices to represent a boarding pass for a flight. The code is generated based on the actions and input of the user checking in to the flight and then transmitted to the user's mobile device for scanning at the airport security desk and/or gate. However, in each situation, symbology-based communication of data is occurring only in a single direction.

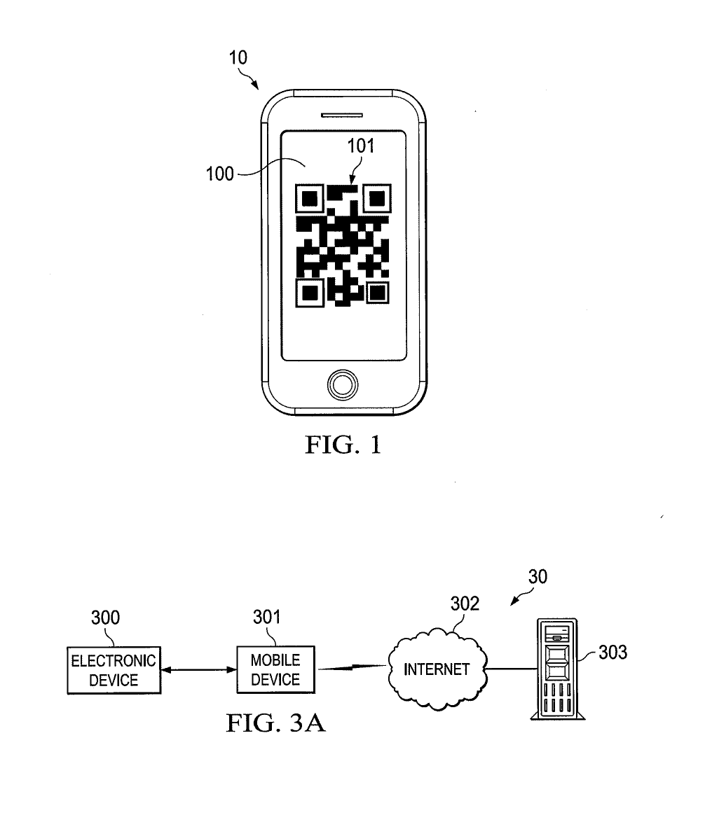

The various embodiments of the present disclosure operate to provide a two-way symbological communication between an electronic device and a user's mobile device. FIG. 1 is a conceptual diagram illustrating mobile device 10 configured according to one embodiment of the present disclosure. Mobile device 10 includes display screen 100 on which various visual elements related to mobile device 10 may be displayed. Display screen 100 may be a touch-sensitive screen or a simple display screen with user input provided for in additional user interface elements of mobile device 10.

As illustrated, optical code 101 is displayed on display screen 100. Optical code 101 may be generated in any number of different ways. For example, mobile device 10 may connect to a mobile network and/or the Internet. Optical code 101 may be received via the network connection of mobile device 10. Thus, it may represent any number of different pieces of data, such as an access code, a identification data, a monetary value, or the like. Optical code 101 may also be generated by an application stored locally on mobile device 10. The user may enter data, such as identification (ID) data, personal information, or the like, and the application encodes that user-entered information into optical code 101. This information, whether user-entered or obtained via the network connection of mobile device 10, can be represented in optical code 101 and displayed via display screen 100.

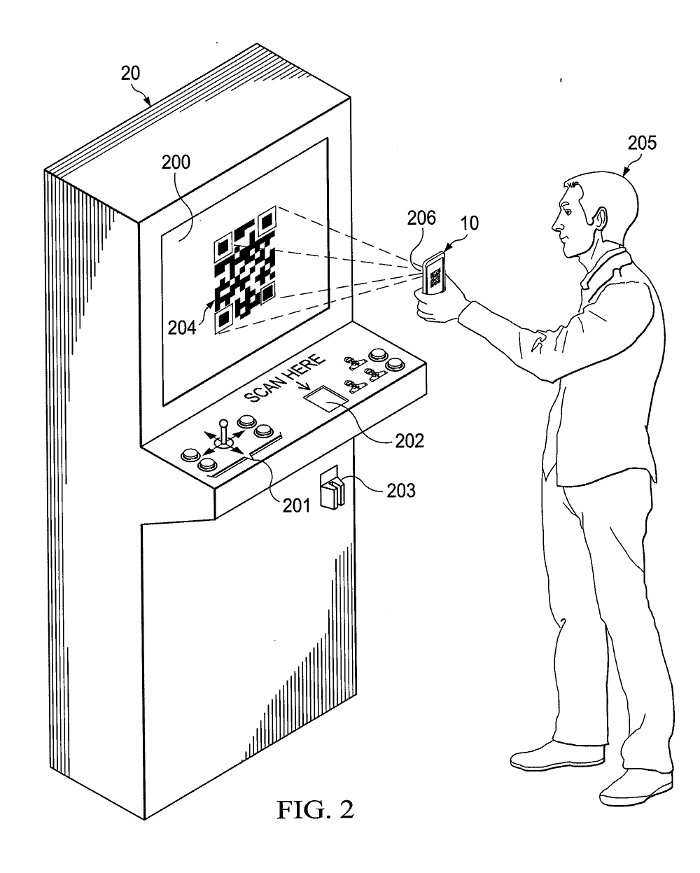

FIG. 2 is a conceptual diagram illustrating game device 20 configured according to one embodiment of the present disclosure. Game device 20 includes game screen 200 on which visual data is presented to player 205. This visual data includes the game animations, splash screens, and the like. Game device 20 also includes user controls 201 for controlling game play, card scanner 203 for scanning electronic or magnetic game cards used to exchange game credits or other indicia of game access or monetary value to allow player 205 to access and play the underlying game of game device 20. Game device 20 also includes optical scanner 202. Optical scanner 202 operates to read optical codes or symbologies from a user device, such as mobile device 10.

For purposes of the example embodiment illustrated in FIG. 2, optical code 101 (FIG. 1) represents a number of game credits available to player 205. When player 205 wishes to play the underlying game of game device 20, he or she calls up the display of optical code 101 (FIG. 1) to be displayed on display screen 100 (FIG. 1), and holds mobile device 10 over optical scanner 202 with display screen 100 (FIG. 1), and, thus, optical code 101 (FIG. 1) facing optical scanner 202. Optical scanner 202 reads optical code 101 (FIG. 1), and, using decoding software built into payment functionality of game device 20, determines how many credits are represented by optical code 101 (FIG. 1). If sufficient credits exist, the payment functionality provides access to the game by player 205. Player 205 then plays the game until he or she wishes to stop. If, during the course of playing the game, the currently expended credits run out, player 205 would have the option to continue playing and using more of his or her available credits, which are already known by game device 20. After game play has been finally completed, the payment functionality calculates the number of remaining credits, after subtracting the credits already used to pay for access to the game, generates change optical code 204 using coding software built into the payment functionality, and displays change optical code 204 on game screen 200. Using camera 206 on mobile device 10, player 205 captures the image of change optical code 204 and stores it in memory on mobile device 10. Thus, the new data stored on mobile device 10 represents the remaining number of game credits that player 205 has left.

Player 205 may obtain optical code 101 (FIG. 1), representing a number of game credits, from any number of different sources. In one example embodiment, player 205 accesses an arcade vendor network via the network connection of mobile device 10. After exchanging monetary value or other such indicia of payment (e.g., coupon, access key, and the like), the arcade vendor transmits optical code 101 (FIG. 1) to mobile device 10. After paying for the game play on game device 20, change optical code 204 is captured optically by mobile device 10. Once captured, application software on mobile device 10 re-establishes communication with the arcade vendor to update the number of remaining credits. Game device 20 may also compile user statistics, record user levels, and the like, based on player 205's game play, and code those statistics and information into change optical code 204 along with the number of remaining game credits. When the communication is re-established between the arcade vendor and mobile device 10, mobile device 10 also communicates the statistics to the arcade vendor. The vendor may then use these statistics to provide displays of where player 205 ranks among other players of the game on game device 20. The vendor may also use administrative statistics which track the overall usage of game device 20 as compared to other game devices the vendor has placed in other locations. The vendor could use this information to make sure that its game devices are getting the optimum traffic.

Moreover, in additional and/or alternative embodiments of the present disclosure, if player 205 returns to game device 20, or game device 20 in another location, for additional game play, on scanning change optical code 204 at optical scanner 202, not only would game credit information be passed to game device 20, but also additional game information, such as game level information, the player's customized avatar or vehicle, depending on the game, personalized color schemes, music choices, or virtually any other customizable option may be passed as well. Therefore, when game play resumes, game device 20 is adjusted using the additional game information allowing player 205 to start playing from the point where he or she stopped playing before, instead of requiring player 205 to start from the beginning and allowing player 205 to play the game customized according to his or her personal preferences also contained in the additional game information.

It should be noted that in various additional and/or alternative embodiments of the present disclosure, the information communicated through the optical symbologies between mobile device 10 and game device 20 may provide for any number of different features or functionalities related to tracking the game play of player 205 and providing player 205 with more personalized service through game device 20. Player 205 may receive coupons contained with change optical code 204 that allows player 205 to obtain free drinks or food, or free play of other games by using change optical code 204. Some of such example features and functionalities are well known in the gaming arts and may be implemented using the various aspects and embodiments of the present disclosure.

It should further be noted that in various additional and/or alternative embodiments of the present disclosure, player 205 may directly create the personalized features for game device 20 at a separate computing device (not shown). The additional game information that supports these personalized features may then either be encoded into an optical symbology for recording by mobile device 10 or the underlying data could be transferred directly to mobile device 10 through a connection to the separate computing device. For example, the application or module that player 205 uses to create the personalized feature on the separate computing device may include encoding software that takes the personalized data and encodes it into an optical symbology for display by the separate computing device. Player 205 would then capture this optical symbology onto mobile device 10 using camera 206.

It should further be noted that in additional and/or alternative embodiments of the present disclosure, mobile device 10 does not have a connection to the Internet, but includes an application that store the data representing a value maintained by player 205 and that may encode that value into an optical code displayed on display screen 100 of mobile device 10. The application may also read change optical code 204 and update the data representing the value stored on mobile device 10. Similarly, game device 20 does not have an Internet connection, but includes the logic able to interpret any optical code read from optical scanner 202 process the code into a value that provides access to game device 20. The embedded code also may calculate the change value and encode that value or any kind of discount or other such benefit into change optical code 204. Player 205 may then have the change value encoded into change optical code 204 or any other type of beneficial value provided by the logic operating on game device 20. Player 205 may then redeem this change value or beneficial value by displaying change optical code 204 on mobile device 10 to any other associated electronic device or again to game device 20. In certain aspects, when another mobile device with an Internet connection interacts with game device 20, game device 20 may encode additional information related to change code 204 delivered to mobile device 10. When the new mobile device connects to the Internet, it would deliver the information related to mobile device 10 and player 205 in the background to an administrative server or application that monitors the two-way symbological communication system in which mobile device 10 and game device 20 operate.

It should be noted that, while the process described with respect to FIG. 2 describes being initiated by mobile device 10, processes configured according to the present disclosure may progress in any manner. For example, a stationary electronic device may always display an optical code that, when captured by mobile device 10, might trigger execution of an application on mobile device 10 or begin access to a website that allows the user to generate a responding optical code for display on mobile device 10. This responding optical code may be provided to an optical scanner of the stationary electronic device displaying the original code or even another electronic device associated with the process. Any number of different procedures may be implemented using various embodiments of the present disclosure. The scope and coverage of the various aspects are not limited to any single order of process.

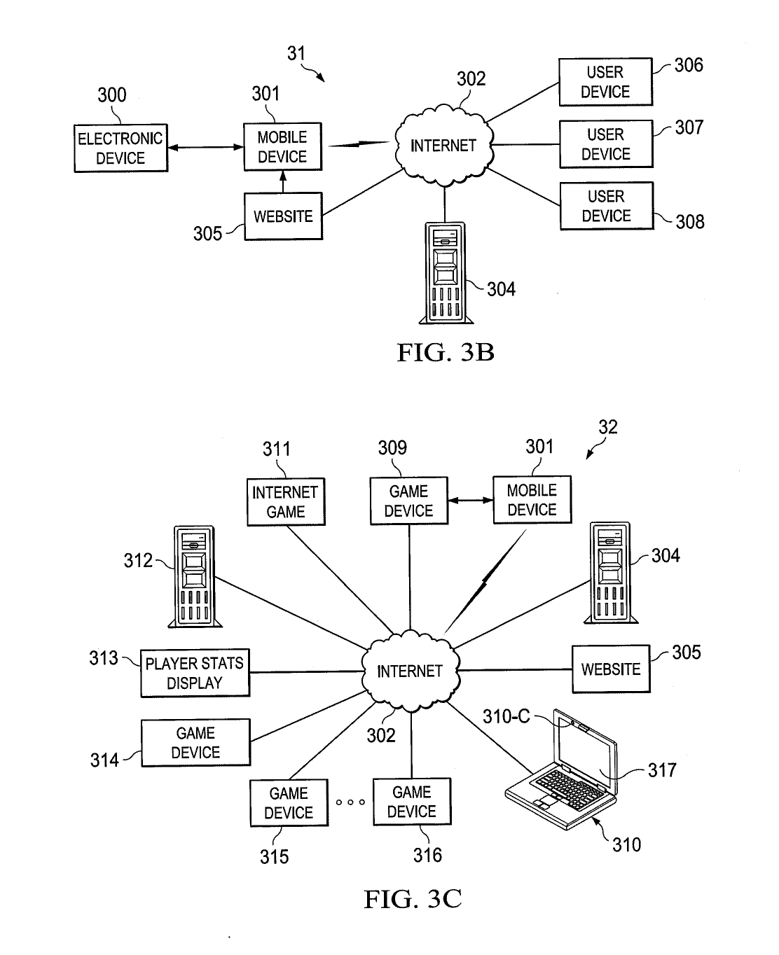

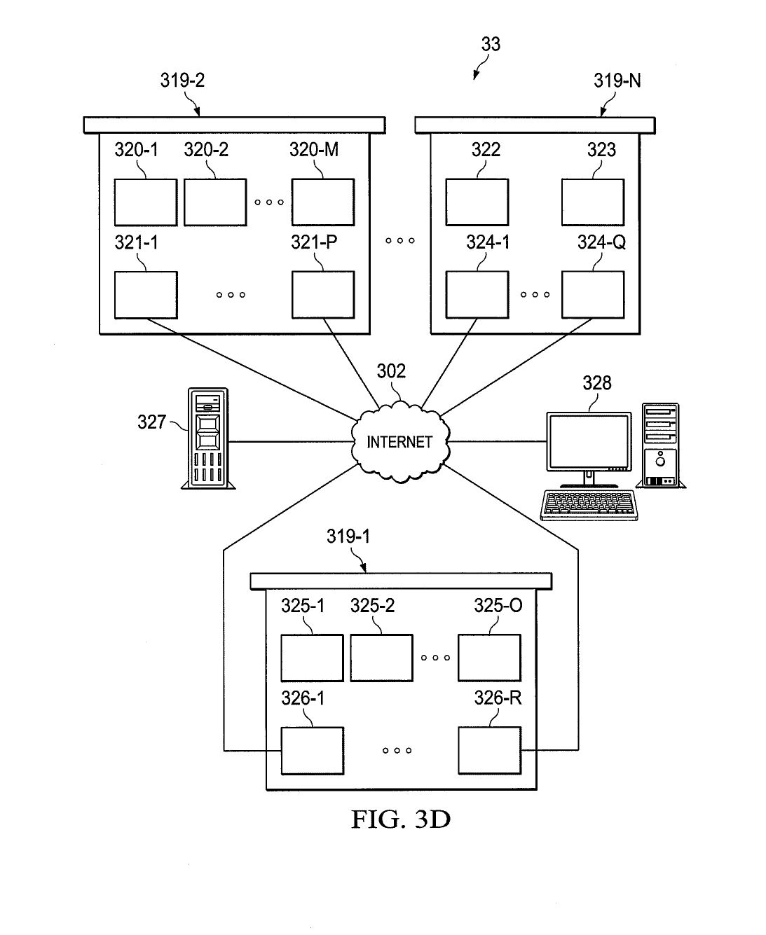

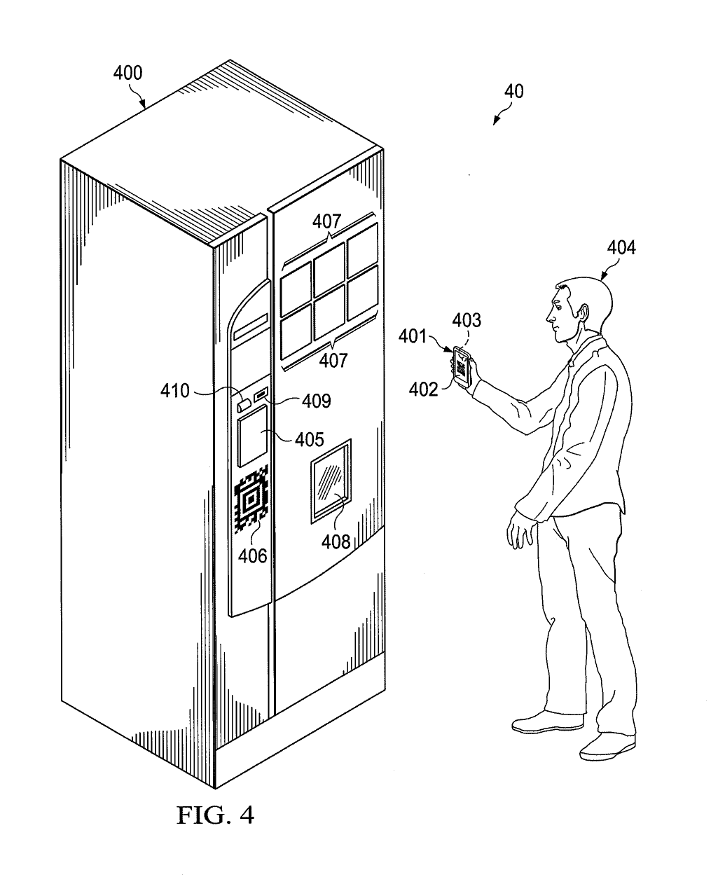

FIG. 3A is a conceptual block diagram illustrating symbological communication system 30 configured according to one embodiment of the present disclosure. The aspect of symbol communication system 30 illustrated in FIG. 3A includes electronic device 300, mobile device 301, and vendor server 303. Both mobile device 301 and vendor server 303 have access to Internet 302 and may, therefore, communicate together via Internet 302. Electronic device 300 is a simple, standalone device without a network connection. It may be a game device, a vending machine, an information kiosk, a point-of-sale kiosk, or any electronic device without a connection to Internet 302. A user activates a symbological communication application on mobile device 301 and manually enters ID information into an input screen generated by the symbological communication application. The application then generates a symbology code representing the ID information and displays the code onto the screen of mobile device 301. The user then presents the displayed code to a code scanner on electronic device 300, which captures and processes the ID information contained in the captured code.

Based on this ID information, electronic device 300 generates an access request and encodes it into a response symbology code which it displays on a visual display of electronic device 300. Using a camera embedded into mobile device 301, the user captures the response symbology code displayed by electronic device. Once this code is captured, the application running on mobile device 301 extracts the access request information and transmits this access request information to vendor server 303 via Internet 302. Vendor server 303 processes the access request which includes not only the ID information from the user, but also additional access information from electronic device 300. This access information may include information regarding the status or accessibility of electronic device 300. For example, if electronic device 300 were a vending machine vending perishable food items, some of the information may pertain to the expiration dates of the food contained within electronic device 300. In another example, electronic device may be a vending machine that vends products available to the general public and also products that may be restricted to certain segments of the population (e.g., alcohol products, tobacco products, and the like). Thus, some of the information may pertain to the restricted nature of some of the available products.

Once vendor server 303 finishes processing the access request, an optical access code is generated and communicated to mobile device 301. The optical access code may be generated with certain access restrictions based on both the user ID information and the status or accessibility information of electronic device 300. Mobile device 301 would then display the optical access code on its display, which the user would then pass over the optical scanner of electronic device 300. Electronic device 300 decodes the optical access code determining the level and ability of access to grant the user of mobile device 301 and provide the appropriate access or service to the user.

It should be noted that, while electronic device 300 has no network connection, it may still be a part of a vendor network by leveraging the network access available to mobile device 301. In communicating with vendor server 303, mobile device 301 would deliver any kind of information generated by electronic device 300 that is included in the optical symbologies communicated between electronic device 300 and mobile device 301. Thus, a passive network may be established in which vendor server 303 is capable of tracking the status and accessibility of electronic device 300 without maintaining a dedicated network link with electronic device 300.

FIG. 3B is a conceptual block diagram illustrating symbological communication system 31 configured according to one embodiment of the present teachings. The aspect of symbol communication system 30 illustrated in FIG. 3B includes electronic device 300, mobile device 301, and vendor server 304. Both mobile device 301 and vendor server 304 have access to Internet 302 and may, therefore, communicate together via Internet 302. Electronic device 300 is a simple, standalone device without a network connection. In the embodiment illustrated, mobile device 301 and electronic device 300 exchange symbologies representing various related information. For example, the user of mobile device 301 displays a first symbology on the display screen and passes the symbology over the optical scanner of electronic device 300. The optical scanner of electronic device 300 may be a light source and a light sensor, with some analyzing software that can analyze the light reflections from the code, it may also be a camera that captures the image of the code along with software to decode the images of the captured code, or any other type of scanner capable of optically reading an optical code.

After some further processing, whether the processing is based on the decoded information from the first symbology or not, electronic device 300 generates a second symbology and displays this second symbology on a display screen to the user. The user then captures the image of the second symbology using the camera or scanner feature of mobile device 301. Application software operating within mobile device 301 provides access to vendor server 304 via Internet 302. Information from the second symbology is exchanged with vendor server 304 according to the features or functionalities associated with the particular implementation. The information transferred to vendor server 304 from mobile device 301 may include ID information related to the user of mobile device 301 or of the mobile device 301 itself. It may also include information regarding the activities performed by the user at electronic device 300 and/or status and accessibility information generated by electronic device 300 without regard to the interactions of the user of mobile device 301.

The aspect of the present disclosure illustrated in FIG. 3B provides for additional mobile devices, user devices 306-308, to communicate with vendor server 304 regarding symbology interactions conducted with electronic device 300. Vendor server 304 then compiles user data and displays some set or subset of user data on website 305. The users of mobile device 301 and user devices 306-308 would then be able to access website 305 to see the user statistics or compiled user data from all usages of electronic device 300. In one example embodiment, electronic device 300 is a testing kiosk. Users of mobile device 301 and user devices 306-308 take a test at electronic device 300. Part of the information that is encoded into the second symbology generated and displayed by electronic device 300 includes grading information, testing time information, statistics regarding commonly missed questions, or the like. When communicating with vendor server 304 over Internet 302, mobile device 301 and user devices 306-308 transmit this information, as received and decoded from the second symbology. Vendor server 304 then compiles the information, calculates any statistics, and uploads this information for display on website 305. Therefore, the user may access website 305 to view the testing data and statistics for all of the users who tested on electronic device 300.

In additional aspects of the present disclosure, website 305 may also contain the particular grade that each user received on the test. These grades may all be coded with a third symbology displayed directly on website 305. In order to find their particular grade, the user captures the image of the third symbology using the camera function of mobile device 301. The application software operating on mobile device 301 uses the user ID information to decode only the user's grade from the third symbology encoding all of the grades. In this manner, each user will only be able to decode their own grade based on the personal ID information contained within their mobile devices, such as mobile device 301 and user devices 306-308.

It should be noted that the system configuration of symbological communication system 31 may be implemented for any variety of different purposes. Instead of a testing kiosk, electronic device 301 may also be a game device, a vending device, or any other electronic device that a user may interact with. The system configuration and functionalities involving user devices 306-308 and website 305 would be tailored to the specific purpose for which symbological communication system 31 is design.

FIG. 3C is a conceptual block diagram illustrating symbological communication system 32 configured according to one embodiment of the present disclosure. Symbological communication system 32 is implemented for a gaming environment comprising game devices 309 and 314-316. Each of game devices 309 and 314-316 is networked with links to internet 302. A user or player of game device 309 uses mobile device 301 to display an optical symbology to a scanner of game device 309. Based on this optical symbology, game device 309 decodes ID and play data encoded within the optical symbology and uses this decoded data in conducting the game play by the user. When the user finishes playing the underlying game on game device 309, an ending optical symbology is displayed on the display screen. The user captures this ending optical symbology using the camera functionality of mobile device 301.

When game play is stopped, game device 309 reports the user's progress or score to central game server 304 via internet 302. Central game server 304 also receives game information reporting from game devices 314-316. Game device 309 and at least one of game devices 314-316 are located in the same gaming site. Central game server 304 provides game statistics and scores to player stat display 313 located at the gaming site. Player stat display 313 is a video display screen that presents various game statistics, including the statistics representative of the game play of the user of mobile device 301. Game play statistics are also provided to player stat website 305, which allow display of such game statistics to parties who access player stat website 305.

The ending optical symbology captured by mobile device 301 includes several different pieces of information. One type of information that is included in the ending optical symbology is a game code that the user can use to access internet game 311 that has a marketing tie in with the underlying game of game devices 309 and 314-316. An application operating on mobile device 301 decodes the game code embedded within the ending optical symbology. The user, using personal computer 310, accesses internet game 311 via internet 302. When asked to log onto internet game 311, the user enters the game code from the ending optical symbology. The user may then play internet game 311.

It should be noted that in additional or alternative embodiments of the present disclosure, instead of the game code being decoded from the ending optical symbology by the application on mobile device 301, the application generates a game code optical symbology for display on mobile device 301. Using webcamera 310-C of personal computer 310, the game code optical symbology is captured and decoded for automatic submission to internet game server 312, which operates internet game 311.

It should further be noted that, after completing play of internet game 311, internet game server 312 generates another end game optical symbology that is transmitted via internet 302 to personal computer 310 for display on display 317. Using mobile device 301, the user captures the end game optical symbology. This end game optical symbology includes free game play credits for the user to play the underlying game of game devices 309 and/or 314-316. The user may then redeem the free game credits by displaying the end game optical symbology on mobile device 301 and passing over the optical scanners of any of game devices 309 and/or 314-316. As such, data may be communicated between game devices 309 and 314-316 and mobile device 301 or other such mobile devices for various reasons in symbological communication system 32.

It should further be noted that in additional and/or alternative embodiments of the present disclosure, game level information included in the ending optical symbology captured by mobile device 301 may allow the user to begin playing the underlying game again from the point at which he or she stopped playing or even allow the user to play hidden/special stages, special characters, or any other special hidden parts of the game not generally available to other normal players of the game. Because this game level information is contained in the ending optical symbology, the user can continue playing the game or open these hidden parts of the game from any of game devices 309 or 314-316. Game devices 309 and 314-316 decode the game level information embedded in the ending optical symbology and generates the game environment according to that information. In still other alternative embodiments, game devices 309 and 314-316 would use the ID data embedded in the ending optical symbology and access the game level data from central game server 304. Thus, this feature would be implementable using networked game devices, such as game devices 309 and 314-316 or non-networked game devices, such as certain embodiments of electronic device 300 (FIGS. 3A and 3B).

It should further be noted that in additional and/or alternative embodiments of the present disclosure, the user may obtain an application operable on mobile device 301 or, alternatively, an application accessible via personal computer 310, such as on a specialized website, that allows the user to customize various features of the underlying game environment. For example, these applications may allow the user to create a customized avatar, vehicle, weapon, artwork, music, or any other such customizable game feature. When finished, the application encodes this additional customizing data into a new optical symbology that adds this customizing data to the information already encoded in the ending optical symbology. The user may get this new optical symbology onto mobile device 301 through the application. For example, if the application is run on mobile device 301, then the application would simply store the symbology onto the memory of mobile device 301. If the application were accessed from another computing device, such as through personal computer 310, or via a website, the new symbology could either be displayed for capture by the camera on mobile device 301 or the underlying data could be transferred directly to mobile device 301 through a communication link with the separate mobile device. Therefore, when the user accesses the game on any of game devices 309 and 314-316, this customizing data is also decoded from the optical symbology and used by the game code to customize the gaming environment experienced by the user.

FIG. 3D is a conceptual block diagram illustrating symbological communication system 33 configured according to one embodiment of the present disclosure. Symbological communication system 33 is an example of a passive network implemented to network a number of electronic devices that do not, themselves, have a direct link to the network, such as internet 302. The illustrated aspect of symbological communication system 33 includes multiple activity locations 319-1-319-N each with multiple electronic devices 320-1-320-M, 322, 323, and 325-1-325-O. Activity locations 313-1-319-N may be any number of different places. For example, activity locations 319-1-319-N may be banks, shopping malls, arcades, combinations of the foregoing, or the like. Electronic devices 320-1-320-M, 322, 323, and 325-1-325-O may be various types of electronic devices, such as automatic teller machines (ATMs), vending machines, kiosks, game devices, or the like. Each of electronic devices 320-1-320-M, 322, 323, and 325-1-325-O may have different data or information that the operator of the devices would like to track depending on the type of device and its operation. In normal operations of electronic devices 320-1-320-M, 322, 323, and 325-1-325-O, users interact with the devices, at least in part, using mobile devices 321-1-321-P, 324-1-324-Q, and 326-1-326-R, by visually exchanging optical codes, having information embedded therein, displayed and captured by the particular devices. Each of mobile devices 321-1-321-P, 324-1-324-Q, and 326-1-326-R has access capability with internet 302. At least part of the information embedded in such optical codes includes the information that operators desire to track and manage.

As this information is decoded by applications running on mobile devices 321-1-321-P, 324-1-324-Q, and 326-1-326-R, mobile devices 321-1-321-P, 324-1-324-Q, and 326-1-326-R transmit the information to operator server 327 via internet 302. Mobile devices 321-1-321-P, 324-1-324-Q, and 326-1-326-R may perform this transmission in the background processes, which may be unnoticed by the user. Such functionality may be used when there are no costs associated with the transmissions charged to the user or where the user is aware of the transmission. The information for tracking electronic devices 320-1-320-M, 322, 323, and 325-1-325-O may then be compiled and processed for presentation in various formats.

Additionally, operators may provide configuration information for electronic devices 320-1-320-M, 322, 323, and 325-1-325-O using work stations, such as work station 328, to send such configuration information to operator server 327. Then, while in communication with one or more of mobile devices 321-1-321-P, 324-1-324-Q, and 326-1-326-R, operator server 327 transmits additional optical codes that contain the configuration information embedded therein to one or more of mobile devices 321-1-321-P, 324-1-324-Q, and 326-1-326-R. The next time that a user interacts with one or more of electronic devices 320-1-320-M, 322, 323, and 325-1-325-O using mobile devices 321-1-321-P, 324-1-324-Q, and 326-1-326-R, mobile devices 321-1-321-P, 324-1-324-Q, and 326-1-326-R will display the optical code with the configuration information embedded therein for scanning by the associated one of electronic devices 320-1-320-M, 322, 323, and 325-1-325-O. Electronic devices 320-1-320-M, 322, 323, and 325-1-325-O will then decode the optical code and use the configuration information to update its configuration. Thus, even without a direct link to internet 302, electronic devices 320-1-320-M, 322, 323, and 325-1-325-O may be networked with operator server 327 by leveraging the network connection to internet 302 of mobile devices 321-1-321-P, 324-1-324-Q, and 326-1-326-R.

It should be noted that in additional and/or alternative embodiments of the present disclosure, when a mobile device receives optical codes from an electronic device, transmits the embedded information to a central server, and then receives new optical codes from the central server. Applications either running within the mobile devices or at the central server operate to modify the optical codes to retain much of the original information related to user ID, access privileges, or the like, but then also embed the additional information or configuration instructions into the optical code. Thus, the resulting optical codes will be slightly different containing both the original ID or such data, and the new information.

FIG. 4 is a conceptual diagram illustrating symbological vending system 40 configured according to one embodiment of the present disclosure. Vending machine 400 is configured to dispense consumer products, such as soda, candy, or the like. Vending machine 400 accepts monetary indicia through bill reader 409, coin slot 410, and the like. A user would enter this monetary indicia and select the particular consumer product associated with product buttons 407. Vending machine 400 would then deliver the selected consumer product via dispenser 408.

Vending machine 400 also includes optical scanner 405. User 404 has mobile device 401 which displays optical symbology 402 that represents monetary indicia. By passing optical symbology 402 over optical scanner 405, vending machine 400 can decode and process the monetary indicia embedded in optical symbology 402 in order to release a selected consumer product via dispenser 408. Vending machine 400 will then display a change optical symbology on display 406, which user 404 may capture onto mobile device 401 using camera 403 embedded into mobile device 401. The change optical symbology would represent the remaining monetary indicia that user 404 still has after purchasing the dispensed consumer product.

It should be noted that user 404 may maintain the monetary indicia that can be converted into optical symbology 402 on mobile device 401 or may obtain the monetary indicia or optical symbology 402 by accessing a vending network site through the network capability of mobile device 401. Therefore, mobile device 401 may act as an electronic wallet, or may provide immediate access to the monetary value of optical symbology 402 through ad hoc access to the vending network.

It should further be noted that, in additional and/or alternative embodiments of the present disclosure, the vending machine network company could provide a simple customer loyalty program that may also be accessible through mobile device 401. For example, in implementation of such a customer loyalty program, the vending machine company could provide for every 5^{th} vending transaction using optical symbology 402 on mobile device 401 for free or, alternatively, could provide customer personalization by thanking user 404 personally by name, based on the ID data received in the optical symbology 402. The part of the vending application running on mobile device 401 would read the ID data and generate a message for user 404, such as, “Thank you for your patronage, Chris.” It could also include a simple game as part of the application program in mobile device 401 where user 404 could win a free vending transaction from vending machine 400. These and many other potential marketing options would be available to keep user 404 loyal to this vendor network.

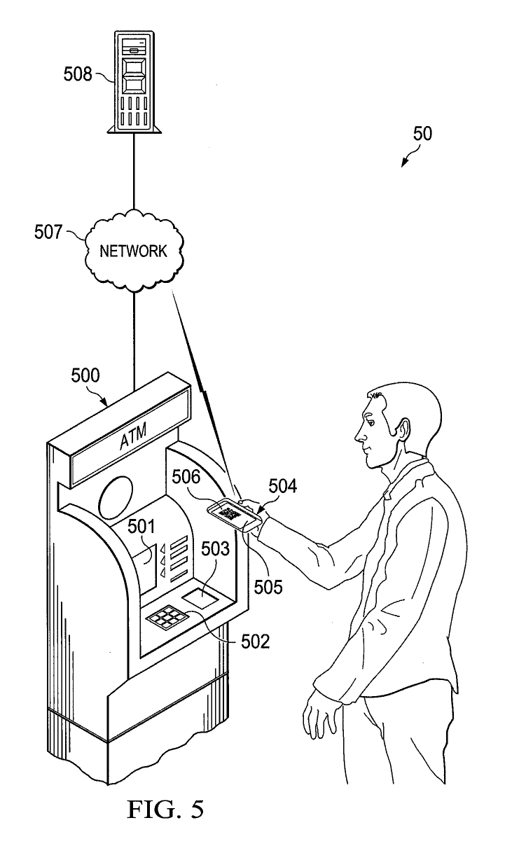

FIG. 5 is a conceptual block diagram illustrating symbological ATM network 50 configured according to one embodiment of the present teachings. The aspect of symbological ATM network 50 shown in FIG. 5 includes ATM 500 which is networked to financial system server 508 via network 507. ATM 500 includes display touch screen 501, keypad 502, and optical scanner 503. Optical scanner 503 is configured to read optical codes presented by user mobile devices, such as mobile device 504.

In operation of a typical ATM, a user will insert a credit/debit card into a magnet or capacitive coupling card reader, enter a personal identification number (PIN) on a keypad, whether a physical keypad or a virtual keypad displayed on a touch screen display, and then begin the desired financial transaction. ATM transactions present various security risks for individuals. Criminals have added skimming card readers, which read the encoded data on user's credit/debit cards, have added touch-sensitive overlays over keypads, which can record user PINs, sometimes work in combinations of electronic skimmers to read card data while a lookout is positioned to see the user enter the PIN, and the like. Many of these such criminal tactics allow the user's account and access information to be available to the criminals without requiring the criminal to assault or perform some kind of violent action against the user.

The embodiment of the present disclosure illustrated in FIG. 5 allows for greater safety measures to be used for users' ATM transactions. For example, many financial institutions offer mobile applications that can be downloaded and operated on a user's mobile device, such as mobile device 504. Thus, the user may obtain access to his or her account through use of the application running on mobile device 504. As the user desires to conduct an ATM transaction at ATM 500, he or she enters a PIN into mobile device 504 operating the financial application. Because the PIN is entered into mobile device 504, it will not be intercepted by any additional unauthorized electronic readers or scanners or lookouts positioned to see keypad 502 of ATM 500. In response to verifying the PIN, the financial application generates optical symbology 506 for display on mobile display 505. Optical symbology 506 not only includes a user PIN, but also includes encoded account information, ID information for the user, as well as ID information associated with mobile device 504. The user would scan optical symbology 506 over optical scanner 503. Without inserting a credit/debit card into a card reader or entering a PIN into keypad 502, the user would gain access to ATM 500 for financial transactions when ATM 500 decodes and verifies optical symbology 506. ATM 500 verifies the access information decoded from optical symbology 506 either locally or by transmitting this information to financial system server 508 via network 507. Once verified, ATM 500 allows the user to perform the desired transaction.

When the transaction is completed, ATM 500 displays an encoded receipt symbology on display touch screen 501, which the user may capture on mobile device 504 using the camera functionality (not shown). The financial application could then decode the receipt symbology and use the receipt information to update any financial recording software on mobile device 504 and also possibly communicate with financial system server 508 via network 507 to verify the transaction further.

It should be noted that in additional and/or alternative embodiments of the present disclosure, the user may select to obtain money either in the form of cash, monetary indicia represented by an optical code, or any combination thereof For example, when accessing ATM 500, the user selects to receive $100.00 USD in cash and $20.00 in electronic indicia. On completion of the transaction, the receipt symbology captured by mobile device 504 from display touch screen 501 includes encoded information that instructs the financial application operating on mobile device 504 that $20.00 will be electronically available for use by the user through display of representative optical codes. Thus, the user may access game devices, vending machines, kiosks, or the like, that require some kind of monetary indicia for access by prompting mobile device 504 to generate an optical code for scanning by such electronic devices that represents the monetary indicia maintained in the memory of mobile device 504.

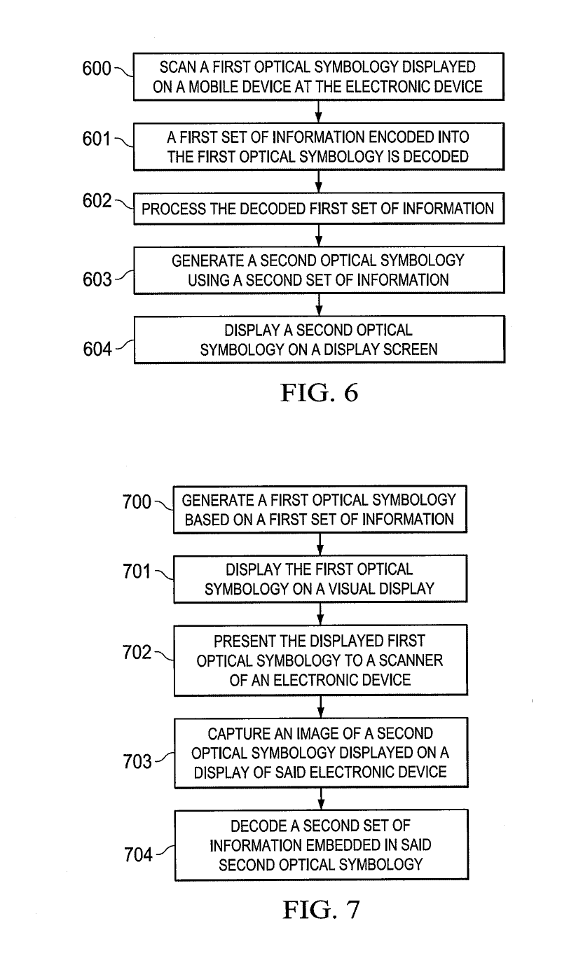

FIG. 6 is a functional block diagram illustrating example blocks executed at an electronic device to implement one embodiment of the present disclosure. In block 600, a first optical symbology displayed on a mobile device is scanned at the electronic device. A first set of information encoded into the first optical symbology is decoded in block 601. In block 602, the decoded first set of information is processed. A second optical symbology is generated, in block 603, using a second set of information. In block 604, a second optical symbology is displayed on a display screen.

FIG. 7 is a functional block diagram illustrating example blocks executed at a mobile device to implement one embodiment of the present disclosure. In block 700, a first optical symbology is generated based on a first set of information. The first optical symbology is displayed, in block 701, on a visual display. The displayed first optical symbology is presented to a scanner of an electronic device in block 702. In block 703, an image of a second optical symbology displayed on a display of said electronic device is captured. A second set of information embedded in said second optical symbology is decoded in block 704.

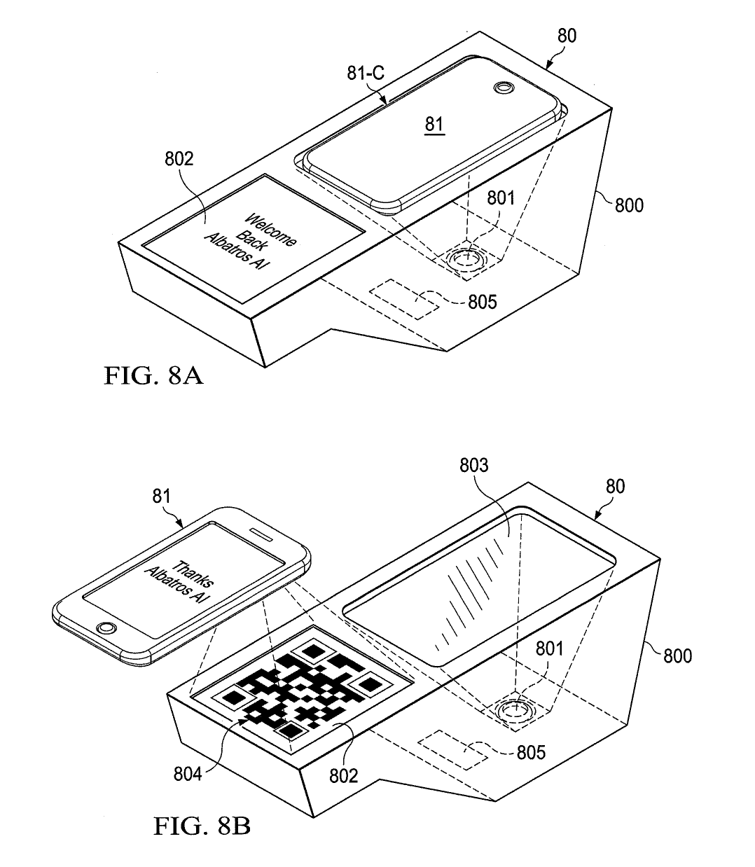

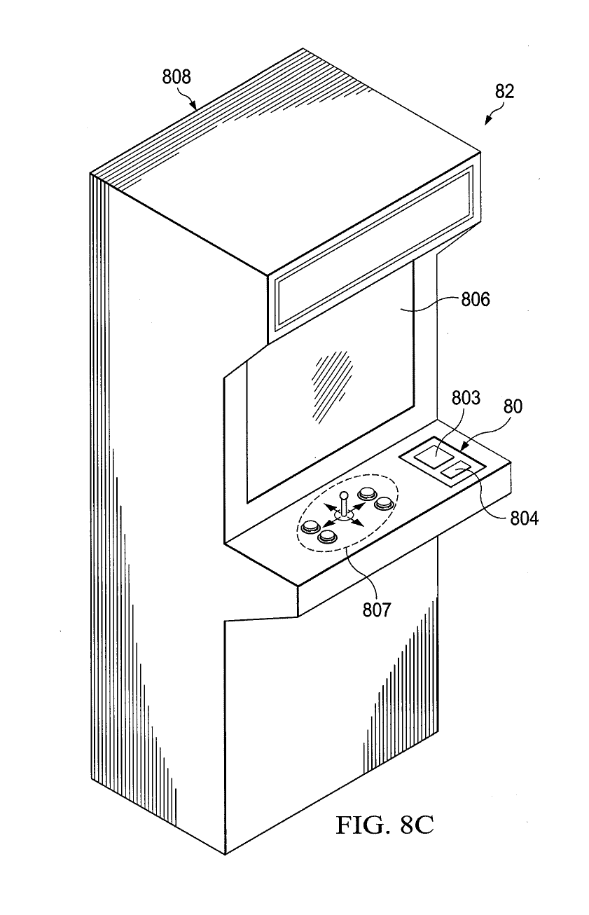

FIGS. 8A and 8B are perspective diagrams illustrating optical scanner unit 80 configured according to one embodiment of the present disclosure. The various embodiments of the present disclosure may be adapted to existing electronic devices through modular scanning devices, such as optical scanner unit 80. Optical scanner unit 80 is a self-contained electronic scanning device that supports two-way symbological communication. Optical scanner unit 80 includes housing 800 which contains camera 801, display 802, scanning surface 803, and electronics interface 805. In operation, to receive symbological communication from a user, the user places mobile device 81, which has an optical symbology displayed on its display, face down onto scanning surface 803. Camera 801 captures the image of the optical symbology, which is then interpreted or processed at electronics interface 805. Electronics interface 805 represents a collection of electronic components, including processors, memory, and the like, that enable optical scanner unit 80 to receive and display communicating symbological images in a self-contained manner. Electronics interface 805 also includes interface couplings that allow for optical scanner unit 80 to be attached to or incorporated into a host electronic device, such as gaming device 82 (FIG. 8C), when not operating as a stand-alone device.

Optical scanner unit 80 transmits communication by displaying optical symbology 804 onto display 802. The user may receive this communication by capturing the image of optical symbology 804 through camera 81-C of mobile device 81. Applications operating on mobile device 81 then translate and, where indicated, display any messages to the user on the display of mobile device 81.

FIG. 8C is a perspective diagram illustrating gaming device 82 configured according to one embodiment of the present disclosure. Gaming device 82 by itself is a typical gaming device. It includes game cabinet 808, display 806, and user controls 807. However, gaming device 82 has been retrofitted with optical scanner unit 80 in such a manner that scanning surface 803 and display 802 are accessible from the exterior of game cabinet 808. Optical scanner unit 80 is coupled to the electronics (not shown) of gaming device through electronics interface 805. The incorporation of the two-way symbological communication capabilities of optical scanner unit 80 into gaming device 82 allows any variety of symbological communication features to be implemented with the underlying game of gaming device 82.

It should be noted that, while optical scanner unit 80 is illustrated as an additional part of gaming device 82, the various aspects of the present disclosure are not limited for use in only gaming devices. For example, optical scanner unit 80 may used in connection with an access gate where the two-way symbological communication allows access through the gate. Optical scanner unit 80 may also be used in connection with a supermarket or retail facility where the two-way symbological communication allows not only for payment, but also for a more personalized shopping experience. The different aspects of the present disclosure are not limited in scope to their application to any one particular field.

Embodiments, or portions thereof, may be embodied in program or code segments operable upon a processor-based system (e.g., computer system or computing platform) for performing functions and operations as described herein. The program or code segments making up the various embodiments may be stored in a computer-readable medium, which may comprise any suitable medium for temporarily or permanently storing such code. Examples of the computer-readable medium include such tangible computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

Embodiments, or portions thereof, may be embodied in a computer data signal, which may be in any suitable form for communication over a transmission medium such that it is readable for execution by a functional device (e.g., processor) for performing the operations described herein. The computer data signal may include any binary digital electronic signal that can propagate over a transmission medium such as electronic network channels, optical fibers, air, electromagnetic media, radio frequency (RF) links, and the like, and thus the data signal may be in the form of an electrical signal, optical signal, radio frequency or other wireless communication signal, etc. The code segments may, in certain embodiments, be downloaded via computer networks such as the Internet, an intranet, a local area network (LAN), a metropolitan area network (MAN), a wide area network (WAN), the public switched telephone network (PSTN), a satellite communication system, a cable transmission system, cell phone data/voice networks, and/or the like.

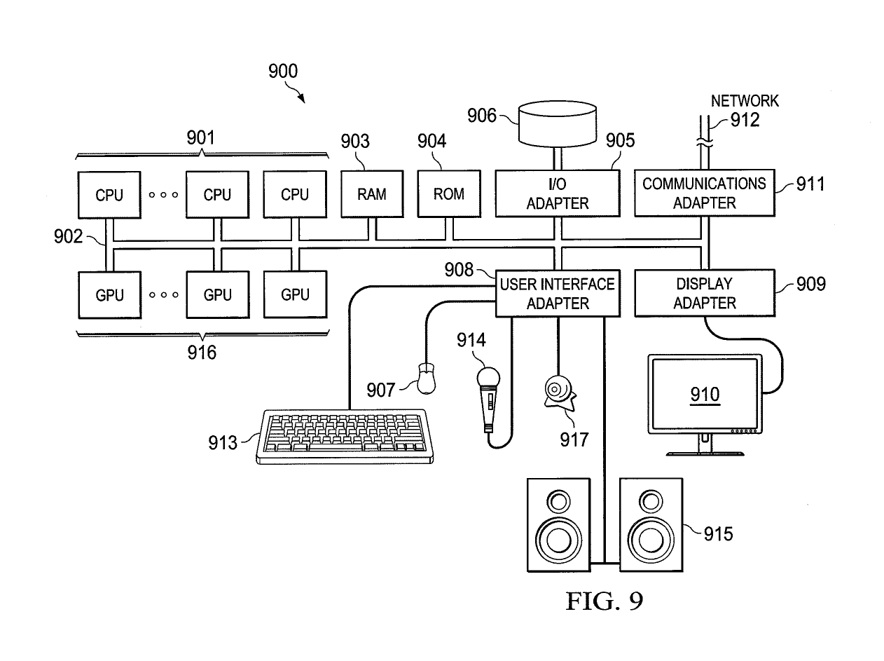

FIG. 9 illustrates exemplary computer system 900 which may be employed to implement the various aspects and embodiments of the present disclosure. Central processing unit (“CPU” or “processor”) 901 is coupled to system bus 902. CPU 901 may be any general-purpose processor. The present disclosure is not restricted by the architecture of CPU 901 (or other components of exemplary system 900) as long as CPU 901 (and other components of system 900) supports the inventive operations as described herein. As such CPU 901 may provide processing to system 900 through one or more processors or processor cores. CPU 901 may execute the various logical instructions described herein. For example, CPU 901 may execute machine-level instructions according to the exemplary operational flow described above in conjunction with FIGS. 6 and 7 and any of the other processes described with respect to illustrated embodiments. When executing instructions representative of the operational steps illustrated in FIGS. 6 and 7 and any of the other processes described with respect to illustrated embodiments, CPU 901 becomes a special-purpose processor of a special purpose computing platform configured specifically to operate according to the various embodiments of the teachings described herein.

Computer system 900 also includes random access memory (RAM) 903, which may be SRAM, DRAM, SDRAM, or the like. Computer system 900 includes read-only memory (ROM) 904 which may be PROM, EPROM, EEPROM, or the like. RAM 903 and ROM 904 hold user and system data and programs, as is well known in the art.

Computer system 900 also includes input/output (I/O) adapter 905, communications adapter 911, user interface adapter 908, and display adapter 909. I/O adapter 905, user interface adapter 908, and/or communications adapter 911 may, in certain embodiments, enable a user to interact with computer system 900 in order to input information.

I/O adapter 905 connects to storage device(s) 906, such as one or more of hard drive, compact disc (CD) drive, floppy disk drive, tape drive, etc., to computer system 900. The storage devices are utilized in addition to RAM 903 for the memory requirements of the various embodiments of the present disclosure. Communications adapter 911 is adapted to couple computer system 900 to network 912, which may enable information to be input to and/or output from system 900 via such network 912 (e.g., the Internet or other wide-area network, a local-area network, a public or private switched telephony network, a wireless network, any combination of the foregoing). User interface adapter 908 couples user input devices, such as keyboard 913, pointing device 907, microphone 914, and camera 917 and/or output devices, such as speaker(s) 915 to computer system 900. Display adapter 909 is driven by CPU 901 and/or by graphical processing unit (GPU) 916 to control the display on display device 910 to, for example, present the results of the simulation. GPU 916 may be any various number of processors dedicated to graphics processing and, as illustrated, may be made up of one or more individual graphical processors. GPU 916 processes the graphical instructions and transmits those instructions to display adapter 909. Display adapter 909 further transmits those instructions for transforming or manipulating the state of the various numbers of pixels used by display device 910 to visually present the desired information to a user. Such instructions include instructions for changing state from on to off, setting a particular color, intensity, duration, or the like. Each such instruction makes up the rendering instructions that control how and what is displayed on display device 910.

It shall be appreciated that the present disclosure is not limited to the architecture of system 900. For example, any suitable processor-based device or multiple such devices may be utilized for implementing the various embodiments of the present disclosure, including without limitation personal computers, laptop computers, computer workstations, multi-processor servers, and even mobile telephones. Moreover, certain embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Although the present teachings and their advantages have been described in detail, it should be understood that various changes, substitutions and alterations can be made herein without departing from the technology of the teachings as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present teachings. Accordingly, the appended claims are intended to include within their scope such processes, machines, manufacture, compositions of matter, means, methods, or steps.

What is claimed is:

1. A method of communication comprising:
scanning a first optical symbology at a first electronic device, said first optical symbology displayed on a second electronic device;
decoding, at said first electronic device, a first set of information encoded into said first optical symbology;
processing, at said first electronic device, said decoded first set of information;
generating a second optical symbology using a second set of information at said first electronic device; and
displaying said second optical symbology on a display screen of said first electronic device.

2. The method of claim 1 further comprising:
granting access to one of: said first electronic or another electronic device, by a user based, at least in part, on said decoded first set of information.

3. The method of claim 1 wherein said second set of information is based, at least in part, on said first set of information.

4. The method of claim 1 wherein said second set of information is based, at least in part, on interaction by a user with another electronic device.

5. The method of claim 1 further comprising:
scanning, at said first electronic device, another optical symbology from said second electronic device;
decoding, at said first electronic device, said second set of data and customizing data from said another optical symbology; and
processing, at said first electronic device, said decoded second set of data and said customizing data.

6. The method of claim 1 further comprising:
reporting at least a portion of said first set of information to a remote server; and
receiving data for at least a portion of said second set of information from said remote server.

7. The method of claim 6 wherein said reporting and said receiving are accomplished through one of:
a direct network connection; or
a network connection of said mobile device.

8. The method of claim 7 wherein said reporting and said receiving are performed by one or more of:
said first electronic device;
said second electronic device; and
another electronic device.

9. The method of claim 1 wherein said first electronic device comprises a stationary electronic device and said second electronic device comprises a mobile device.

10. A method of communication comprising:
generating a first optical symbology based on a first set of information;
displaying said first optical symbology on a visual display;
presenting said displayed first optical symbology to a scanner of an electronic device;
capturing an image of a second optical symbology displayed on a display of said electronic device; and
decoding a second set of information embedded in said second optical symbology.

11. The method of claim 10 wherein said first set of information is one of:
received from a remote server over a network connection; or detected from input entered by a user.

12. The method of claim 10 further comprising:
generating a third optical symbology based on said second set of information and customizing data created by a user on a computing device separate from said electronic device;
displaying said third optical symbology on said visual display; and
presenting said displayed third optical symbology to said scanner.

13. The method of claim 12 wherein said computing device comprises another electronic device separate from said electronic device.

14. A computer program product for symbological communication, comprising:
a computer-readable medium having program code recorded thereon, said program code comprising:
program code to scan a first optical symbology at a first electronic device, said first optical symbology displayed on a second electronic device;
program code to decode, at said first electronic device, a first set of information encoded into said first optical symbology;
program code to process, at said first electronic device, said decoded first set of information;
program code to generate a second optical symbology using a second set of information at said first electronic device; and
program code to display said second optical symbology on a display screen of said first electronic device.

15. The computer program product of claim 14 wherein said program code to scan comprises:
program code to grant access to one of: said first electronic or another electronic device, by a user based, at least in part, on said decoded first set of information.

16. The computer program product of claim 1 wherein said second set of information is based, at least in part, on said first set of information.

17. The computer program product of claim 14 wherein said second set of information is based, at least in part, on interaction by a user with another electronic device.

18. The computer program product of claim 14 further comprising:
program code to scan, at said first electronic device, another optical symbology from said second electronic device;
program code to decode, at said first electronic device, said second set of data and customizing data from said another optical symbology; and
program code to process, at said first electronic device, said decoded second set of data and said customizing data.

19. The computer program product of claim 14 further comprising:
program code to report at least a portion of said first set of information to a remote server; and
program code to receive data for at least a portion of said second set of information from said remote server.

20. The computer program product of claim 19 wherein said program code to report and said program code to receive are accomplished through one of:
a direct network connection; or
a network connection of said mobile device.

21. The computer program product of claim 20 wherein said program code to report and said program code to receive are performed by one or more of:
said first electronic device;
said second electronic device; and
another electronic device.

22. The computer program product of claim 1 wherein said first electronic device comprises a stationary electronic device and said second electronic device comprises a mobile device.

23. A computer program product for symbological communication, comprising:
a computer-readable medium having program code recorded thereon, said program code comprising:
program code to generate a first optical symbology based on a first set of information;
program code to display said first optical symbology on a visual display;
program code to present said displayed first optical symbology to a scanner of an electronic device;
program code to capture an image of a second optical symbology displayed on a display of said electronic device; and
program code to decode a second set of information embedded in said second optical symbology.

24. The computer program product of claim 23 wherein said first set of information is one of:
received from a remote server over a network connection; or detected from input entered by a user.

25. The computer program product of claim 23 further comprising:
program code to generate a third optical symbology based on said second set of information and customizing data created by a user on a computing device separate from said electronic device;
program code to display said third optical symbology on said visual display; and
program code to present said displayed third optical symbology to said scanner.

26. The computer program product of claim 25 wherein said computing device comprises another electronic device separate from said electronic device.

27. An electronic device comprising
at least one processor;
a display device coupled to said at least one processor;
an image capture device coupled to said at least one processor;
a memory coupled to said at least one processor, and
a symbological communication module stored on said memory, wherein when executed by said at least one processor, said executing symbological communication module configures said electronic device to:
scan a first optical symbology at a first electronic device, said first optical symbology displayed on a second electronic device;
decode, at said first electronic device, a first set of information encoded into said first optical symbology;
process, at said first electronic device, said decoded first set of information;
generate a second optical symbology using a second set of information at said first electronic device; and
display said second optical symbology on a display screen of said first electronic device.

28. The electronic device of claim 27 wherein said executing symbological communication module further configures said electronic device to:
grant access to one of: said first electronic or another electronic device, by a user based, at least in part, on said decoded first set of information.

29. The electronic device of claim 27 wherein said second set of information is based, at least in part, on said first set of information.

30. The electronic device of claim 27 wherein said second set of information is based, at least in part, on interaction by a user with another electronic device.

31. The electronic device of claim 27 wherein said executing symbological communication module further configures said electronic device to:
scan, at said first electronic device, another optical symbology from said second electronic device;
decode, at said first electronic device, said second set of data and customizing data from said another optical symbology; and
process, at said first electronic device, said decoded second set of data and said customizing data.

32. The electronic device of claim 27 wherein said executing symbological communication module further configures said electronic device to:
report at least a portion of said first set of information to a remote server; and
receive data for at least a portion of said second set of information from said remote server.

33. The electronic device of claim 32 wherein said configuration of said electronic device to report and to receive are accomplished through one of:
a direct network connection; or
a network connection of said mobile device.

34. The electronic device of claim 33 wherein said configuration of said electronic device to report and to receive are performed by one or more of:
said first electronic device;
said second electronic device; and
another electronic device.

35. The electronic device of claim 27 wherein said computing device comprises said mobile device.

36. An electronic device comprising
at least one processor;
a visual display device coupled to said at least one processor;
an image capture device coupled to said at least one processor;
a memory coupled to said at least one processor, and
a symbological communication module stored on said memory, wherein when executed by said at least one processor, said executing symbological communication module configures said electronic device to:
generate a first optical symbology based on a first set of information;
display said first optical symbology on said visual display device;
present said displayed first optical symbology to a scanner of another electronic device;
capture an image of a second optical symbology displayed on a display of said another electronic device using said image capture device; and
decode a second set of information embedded in said second optical symbology.

37. The electronic device of claim 36 wherein said first set of information is one of:
received from a remote server over a network connection; or
detected from input entered by a user.

38. The electronic device of claim 36 wherein said electronic device is further configured to:
generate a third optical symbology based on said second set of information and customizing data created by a user on a computing device separate from said another electronic device;
display said third optical symbology on said visual display device; and
present said displayed third optical symbology to said scanner.

39. The mobile device of claim 38 wherein said computing device comprises another electronic device separate from said electronic device.
